(19) United States
(12) Patent Application Publication
(10) Pub. No.: US 2026/0342369 A1
(43) Pub. Date: Oct. 29, 2026

(54) Signaling for Cooperative DPD

(71) Applicant: Telefonaktiebolaget LM Ericsson (publ), Stockholm (SE)

(72) Inventors: Andres Reial, Höllviken (SE); Ali Nader, Malmö (SE); Sina Maleki, Malmö (SE); Jonas Bengtsson, Häljarp (SE); Henrik SJöland, Lund (SE); Rickard Ljung, Helsingborg (SE); Henrik Egnell, Uppsala (SE)

(21) Appl. No.: 19/486,741

(22) PCT Filed: May 23, 2024
(86) PCT No.: PCT/EP2024/064286

§ 371 Date: Nov. 21, 2025

Related U.S. Application Data
(60) Provisional application No. 63/470,006, filed on May 31, 2023.
(60) Provisional application No. 63/470,020, filed on May 31, 2023.

(51) Int. Cl. H04B 1/04

(52) U.S. Cl. CPC H04B 1/0475

(57) ABSTRACT

Methods for sending, receiving, and/or configuration and/or activation signaling for cooperative digital pre-distortion (DPD) processing. A method, in a first device, comprises receiving, from a second device, digital-predistortion (DPD) guidance information, the DPD guidance information being indicative of whether and/or how, and/or to what extent to perform DPD processing at the first device. The method further comprises performing DPD processing at the first device, based on the DPD guidance information. A method, in a second device, comprises sending, to a first device, digital-predistortion (DPD) guidance information, the DPD guidance information being indicative of whether and/or how and/or to what extent to perform DPD processing at the first device.

### TECHNICAL FIELD

This disclosure is generally related to wireless communications and is more particularly related to techniques for compensating for non-linearities in the transmission of radio signals.

### BACKGROUND

Due to their multicarrier structure, traditional Orthogonal Frequency Division Multiplexing (OFDM) signals have an inherently high peak-to-average-power ratio (PAPR), i.e., a high probability of high instantaneous signal magnitude peaks in relation to the average magnitude of the waveform. This is problematic for power-efficient power amplifier (PA) operations, since the peaks may drive the PA to its non-linear input/output mapping region, which will distort the output by attenuating or clipping the corresponding peaks and causing spectral widening whereby adjacent channel interference is created, degrading the adjacent channel leakage ratio (ACLR). To avoid this, the PA needs to be operated in its shallow linear region so that the peaks do not drive it into the non-linear part of the transfer curve. However, this results in low power efficiency since, on average, a moderate fraction of the full power capability is utilized. Operating with such a PA strategy is costly, since PAs with higher peak power need to be used, and the related energy consumption is also high, since the PAs need to be driven at a higher bias voltage.

Minimizing energy consumption in wireless networks, in both UEs and NW nodes is a necessity for supporting constantly increasing bandwidths and data rates with maintained time between charging. PA energy consumption is a major contributor to both user equipment (UE) and network (NW) energy consumption. Numerous approaches have been used for PAPR reduction, e.g., discrete Fourier Transform-spread OFDM (DFTS-OFDM), crest factor reduction (CFR), tone reservation (TR), digital pre-distortion (DPD) processing, and digital post-distortion (DPOD) processing. Some of these techniques, such as DPD and DPOD, have been proposed as a way for 3rd-generation Partnership Project (3GPP) networks to save energy, particularly in higher-load scenarios.

The basic building blocks of DFTS-OFDM, also referred to as Single Carrier Frequency-Division Multiple Access (SC-FDMA), are illustrated in FIG. 1. As seen in FIG. 1, a baseband input signal, which may be referred to as a “modulation symbol,” e.g., comprising quadrature-phase-shift keying (QPSK), 16-quadrature-amplitude modulation (16QAM), or 64QAM modulation symbols, and which may be regarded as being in the frequency-domain (F-domain), with respect to the inverse Fast Fourier Transform (IFFT) operation to be performed later, is input to a discrete Fourier Transform (DFT) operation, to “spread” the input baseband signal across the frequency bins output from the DFT. This is shown in FIG. 1 as the DFTS block. An IFFT operation is then performed on the DFTS block's output. The resulting time-domain signal is then provided to the radio frequency (RF) circuitry, shown as RF FE (front-end)+PA in FIG. 1, for upconversion, amplification, and transmission.

At the receiver end, the reverse processes are performed. After passing through the radio channel, the RF signal is received with a receiver's RF circuitry, shown as LNA (low-noise amplifier)+RF FE in FIG. 1. This block amplifies and downconverts the received radio signal. A Fast Fourier Transform (FFT) is performed, to reverse the IFFT operation performed in the transmitter. Optionally, the output is equalized, to compensate for channel distortions. The DFTS process is reversed, using an inverse DFT. This produces an output signal, again in the “F-domain” with respect to the IFFT and FFT operations, which can be demodulated.

For the purposes of the present disclosure, DFTS-OFDM is regarded as one form of OFDM. Cyclic-prefix OFDM (CP-OFDM), which is used by base stations in LTE networks and which does not include the DFTS step shown in FIG. 1, is another.

Several mitigation approaches may reduce the PAPR or non-linear effects, but each has respective shortcomings. For example, with DFT-spread OFDM, the multi-carrier OFDM signal is converted to single-carrier signal by applying a DFT prior to conversion to the time domain. The resulting signal has a lower PAPR, but the PAPR reduction is moderate and is not robust with respect to channel dispersion. As a consequence, equalization needs to be applied prior to the inverse DFT in the receiver.

Crest factor reduction (CFR) is another example. With CFR, the individual signal peaks are reduced before feeding the signal into the PA, e.g., by soft or hard clipping. Uncontrolled spectral spreading is avoided but considerable signal distortion remains. With tone reservation (TR), another approach, some OFDM subcarriers are reserved and an additive signal component is inserted into the reserved tones, to produce a time-domain contribution that reduces the individual high peaks. However, for a sufficiently strong effect, a large number of reserved tones is required, reducing carrier capacity, and the computation complexity of deriving a suitable additive waveform is high.

Digital pre-distortion (DPD) is another technique. With DPD, the PA input signal is pre-distorted so that the aggregate effect of the pre-distortion and PA distortion is approximately linear. DPD processing is widely used in commercial products in cellular networks and is expected to be useful for PA non-linearity mitigation in many scenarios. The overall distortion at the receiver is reduced or eliminated, however the PA non-linearity, when relying solely on DPD, can still generate excessive spectral leakage, which limits the degree of DPD pre-compensation that may be applied. The computational load of the DPD computations is high and increases as higher fidelity is pursued.

### SUMMARY

The DPD algorithm may be implemented as fully autonomous, but the Applicant has appreciated that coordination and additional information transfer to the transmitter could further improve the efficiency of the solution. There is thus a need for signaling mechanisms to support DPD operation at the transmitter and align with the receiving node. This may include the signaling of information about actual transmitted signal characteristics.

Embodiments of the techniques, apparatuses, and systems described herein may address this need. An example transmitting node (a UE or a gNB) in a wireless network performs DPD processing on the transmitted signal to remove or reduce the non-linear distortion caused by its PA non-linearity. The techniques described herein provide signaling mechanisms by which the receiver (RX) and transmitter (TX) nodes may align their operation and the RX node may provide assistance/support information that is useful for configuring the DPD processing in the TX node.

More specifically, embodiments may provide methods for capability and preference signaling and DPD activation/scheduling, involving any one or more of the following:
DPD capability and related assistance capability signaling
Current preference indication by RX at which distortion level it can operate, and at what DPD processing level or characteristic the TX should operate
Configuration of DPD characteristics to be used by the TX
Signaling from RX a recommended non-linear model to use for DPD and/or available parameters or parameter values for such model
Indication from RX that the TX should apply DPD for transmitting signals (DL) or that TX intends to use DPD for transmission of signals (UL)
Preference indication by TX at which distortion level or NL characteristic it can/would like to operate its DPD UL and DL versions of relevant signaling
Non-linearity info provision capability and preference signaling
Non-linearity estimation based on composite metric
Non-linearity estimation based on NLE-RS, including NLE-RS transmission
Non-linearity characteristic or related performance metric reporting
Configuration and indication when to perform reporting, turn on/off or trigger reporting

Uplink (UL) and downlink (DL) versions of relevant signaling are described.

The described techniques may allow the RX side to assist the DPD algorithm in the TX, for example by providing recommended DPD mode or other assistance information. As a result, the end-to-end system runs with improved performance and/or more energy-efficiently. UE and/or network key performance indicators (KPIs), such as throughput, latency, and quality-of-experience (QoE), may thereby be improved.

According to the present invention, there is provided a method, in a first device. The method comprises receiving, from a second device, digital-predistortion (DPD) guidance information, the DPD guidance information being indicative of whether and/or how, and/or to what extent to perform DPD processing at the first device. The method further comprises performing DPD processing at the first device, based on the DPD guidance information.

Various embodiments for the DPD guidance information are provided.

In an embodiment, the DPD guidance information may comprise non-linearity characteristic, NLC, information, the NLC information indicating a characteristic of and/or an extent of and/or a type of non-linearity in a signal received at the first device.

According to the present invention, there is further provided a method, in a first device. The method comprises sending, to a second device, digital-predistortion (DPD) guidance information, the DPD guidance information being indicative of whether and/or how and/or to what extent to perform DPD processing at the second device. It should be appreciated that the terms “first” and “second” are naming terms, and the “first device” referred to above as receiving the DPD guidance information may be the “second device” in this method, to which the DPD guidance information is sent.

According to the present invention there is further provided an apparatus comprising receiver circuitry, transmitter circuitry, and processing circuitry operatively coupled to the receiver circuitry and transmitter circuitry, wherein the processing circuitry is configured/adapted to use the receiver circuitry and/or transmitter circuitry to carry out a method according to any of the above methods.

There is further provided a network node comprising the apparatus, and a User Equipment, UE, comprising the apparatus. The network node may be a base station.

### BRIEF DESCRIPTION OF THE FIGURES

Some embodiments will now be described more fully, by way of example only, with reference to the accompanying drawings, in which:

FIG. 1 illustrates Discrete-Fourier-Transform-spread OFDM.

FIG. 2 is a block diagram illustrating components of a receiver circuit and a transmitter circuit, providing a setting for the techniques to be described herein.

FIG. 3 is a process flow diagram illustrating steps carried out by a device, according to some embodiments.

FIG. 4 is a process flow diagram illustrating another example method carried out in a device, according to some embodiments.

FIG. 5 is a further process flow diagram illustrating steps carried out by a device, according to some embodiments.

FIG. 6 is a further process flow diagram illustrating another example method carried out in a device, according to some embodiments.

FIG. 7 illustrates an example communication system, according to some embodiments.

FIG. 8 shows an example user equipment (UE) in which the techniques described herein may be implemented, in some embodiments.

FIG. 9 shows an example network node which the techniques described herein may be implemented, in some embodiments.

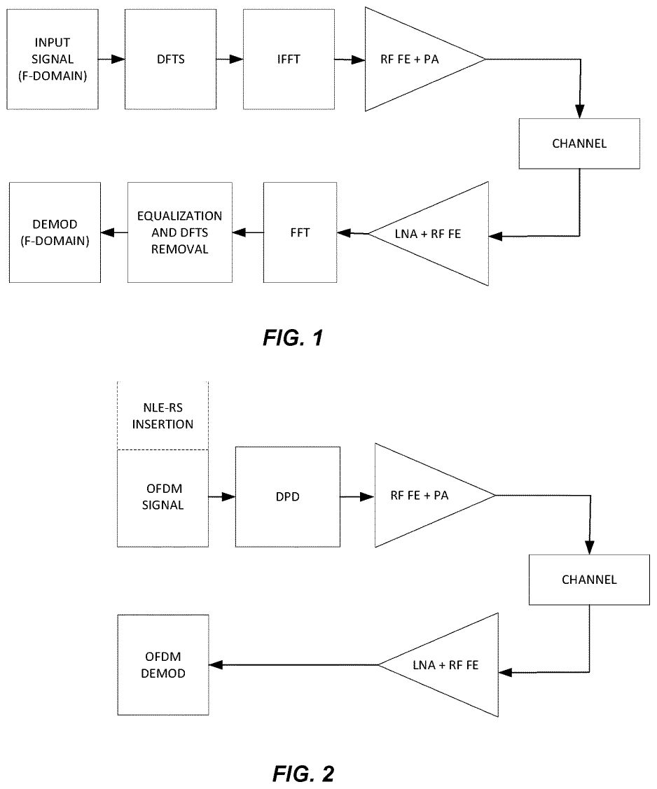

### DETAILED DESCRIPTION

FIG. 2 is a block diagram illustrating components of a receiver circuit and a transmitter circuit, providing a setting for the techniques to be described herein. It will be appreciated that the receiver circuit will be found in a first device, while the transmitter circuit is found in a second device. The first and second devices will include a corresponding transmitter circuit and receiver circuit, respectively. The first and second devices might be a UE and a base station, a base station and a UE, or two UEs, in various embodiments or instances.

The setting for the techniques described herein is that a transmitting node (a gNB in the DL or a UE in the UL or a UE in a sidelink) performs DPD processing before transmitting a signal to remove or reduce the non-linear distortion after the transmitter's power amplifier (PA). In the example embodiments below, the device performing the DPD is mostly referred to as the gNB, or base station. But, similar examples can also be applied to the UE or other types of RX/TX, including devices configured for sidelink, peer-to-peer, or device-to-device operation.

The high-level signal flow may be depicted as conventional OFDM transmission, which may comprise cyclic-prefix OFDM, e.g., as commonly used by eNBs in LTE systems, or Discrete-Fourier-Transform-spread OFDM (DFTS-OFDM), also known as single-carrier frequency-division multiple access (SC-FDMA), e.g., as commonly used by UEs in LTE systems. On the transmitter side, a DPD processing stage is added, before the power amplifier (PA)and other radio frequency (RF) front end (FE) components. On the transmitter (TX) side, optionally, reference symbols (RS) for estimating the residual PA non-linearity, referred to herein as non-linearity estimation reference symbols (NLE-RS), may be inserted in the OFDM signal, or prior to/after the OFDM signal. The RS can also be transmitted for a group of OFDM signals separately, e.g., one RS is transmitted before several OFDM signals, e.g., Physical Downlink Shared Channel, PDSCHs. On the RX side, operational NL distortion estimation may be performed, e.g., based on the transmitted NLE-RS or by other means. Note that “RS” in this and similar contexts may alternatively be interpreted as referring to “reference symbols”—thus, one or more reference symbols make up a reference signal. These usages should be understood as interchangeable in the present document—thus, “NLE-RS” may be understood as referring to either (or both of) non-linearity estimation reference symbols or a non-linearity estimation reference signal.

For conciseness, the term “DPD” is used throughout this document to denote the PA optimization function at the TX. However, the signaling concepts in this document may apply to a broader variety of PA optimization techniques, where some non-limiting examples include DPD (including controlled non-linearity metric or function generation), CFR, TR, VDD scaling, etc., but other schemes are not excluded.

In some embodiments, the signaling approaches described herein may be tailored to implementation details of the selected PA optimization approach but the main ideas are independent of the specific approach.

The techniques described herein may provide signaling mechanisms by which the RX and TX nodes may align their operation and the RX node may provide assistance/support information that is useful for the DPD processing.

The TX and RX may exchange DPD-related feature support/capability information, preference information, configuration information, request and activation signaling, etc. This may include transmitting information indicative of supported DPD functionality, preferred DPD mode info, preferred assistance reporting configuration info, DPD control indication signaling configuration, recommended DPD application patterns or associations with transmission scenarios, control indication requests, DPD configuration info and configuration options list with indicators to select a configuration from the list, etc.

In some embodiments, the RX may signal to the TX whether and/or to what extent to apply DPD, or change the DPD configuration, based on the reception mode. For example, if low-rate or robust Modulation and Coding Scheme, MCS, is used or the NL distortion impact is low compared to noise contribution, the need for DPD may be low or non-existent. If, on the other hand, high modulation orders are used, the TX should apply more efficient DPD.

With respect to DPD processing for the downlink signal, the UE in the DL may assist the gNB in advantageously configuring or activating the DPD functionality so as to minimize the gNB processing load and/or power consumption while maintaining the required received signal quality.

The UE may provide capability information to the gNB indicating that it can generate and report DPD guidance info to the gNB. This capability may be expressed as support of preferred DPD configuration indication, DPD activation indication, DPD mode/change indication, etc. The DPD configuration may be specified in terms of, e.g., distortion metrics (EVM, cubic metric, etc.) describing the extent or characteristic of the NL distortion that may be compensated for, or a NL characteristic or distortion curve/function. This may be signaled via the UE capability reporting framework during the NW attachment procedure or via other control signaling such as Radio Resource Control, RRC, signaling. The capability indication may be frequency-band specific.

In some embodiments, the DPD guidance capability may be dynamic and may depend on the UE energy status or other ongoing processing, and may be reported using dynamic methods, such as a Medium Access Control Control Element (MAC CE) or uplink control information (UCI), including indicating one of preconfigured options as being currently in effect. The list of preconfigured options may be provided by the UE in the above capability reporting or RRC signaling, or by the gNB via RRC signaling.

The UE may provide DPD preference information to the gNB, containing one or more of preferred DPD mode/configuration, desired/acceptable distortion level or distortion shape at TX output, etc. The preference info validity may be until the next preference signaling from the UE. This may be signaled via the UAI framework or via other RRC signaling, for example.

The UE may receive from the gNB a configuration for DPD control indication signaling that may include indication type, indication message format, periodic mode with indication period, aperiodic mode with indication trigger definition, etc. This may be signaled via RRC or MAC CE.

The UE may signal to the gNB a recommendation for DPD application that may include during which transmission formats, channels, symbols, slots, etc., the gNB could apply DPD, e.g., during of one or more scheduled DL signals, e.g., PDSCHs, or during certain scheduling time intervals, e.g., specific slots or symbols, or for certain TX modes or formats (e.g. single-layer DFTS-OFDM transmission, or frequency or bandwidth part related such as operation in FR2 or sub-THz frequency range). This may be signaled via the UAI framework, other RRC or MAC CE.

The UE may signal to the gNB a control indication/request according to the configuration, including [shorter-term] DPD mode indicator, to activate DPD, deactivate DPD, DPD parameter value, or modification to DPD parameters, etc. This may be signaled via MAC CE or via UCI referring to an item in a list of options provided via RRC.

In one example, the UE signals an indication that the gNB can operate in the NL part of PA in the UL and DPD is not required, or a reduced extent of DPD is sufficient, e.g., in case low-MCS signals or Physical Downlink Control Channel, PDCCH-only signals are transmitted. The UE may additionally signal an indication that it applies DPOD and as such the gNB is allowed to operate in the NL domain of PA (e.g., without DPD). The UE may also indicate a target a residual response whose EVM is tolerable for the given transmission without further action, or to enable DPOD with a known function, e.g., third order polynomial, as the target output.

The UE may receive from the gNB a list of predefined DPD configurations/modes and signal to the gNB an indication/request to perform DPD, comprising an index to an entry in the list. Additionally, the configuration may include that the UE can expect that one or more scheduled DL signals/channels are transmitted with DPD applied, e.g., all scheduled DL PDSCH using a DCI associated with a C-RNTI or transmitted with a certain MCS subset, but not PDCCH or lower MCSs. The list may be signaled via RRC or MAC CE and the indication e.g., via UCI or MAC CE.

The UE may receive an indication e.g., as part of a scheduling DCI if gNB applies DPD in one or more of the following scheduled PDSCHs. In one example, if the DCI schedules multiple PDSCH, then indication of DPD application applies to all, unless otherwise indicated or configured, e.g., through higher layer signaling.

In one example, the UE may receive an indication or configuration, e.g., through higher layer signaling that DPD is applied in which beams, or TCI states.

With respect to DPD processing for the uplink (UL), the UE in the UL may receive assistance from the gNB to advantageously configure or activate the DPD functionality so as to minimize UE processing load and/or power consumption while maintaining the required received signal quality.

The UE may signal to gNB a controlled DPD capability info which may include one or more of support of receiving DPD configuration, DPD activation indication, DPD mode/change indication, etc. This may be signaled via the capability reporting framework during the NW attachment procedure or via other RRC signaling. The capability indication may be frequency-band specific.

In one embodiment, the DPD capability may be dynamic and may depend on the UE energy status, processing or memory load status or other ongoing processing, and may be reported using dynamic methods, e.g., MAC CE or UCI, including indicating one of preconfigured options as being currently in effect. The list of preconfigured options may be provided by the UE in the above capability reporting or RRC signaling, or by the gNB via RRC signaling.

The UE may receive from the gNB a DPD configuration, including a DPD mode, a residual non-linear characteristic description, a residual impairment metric, etc. This may be signaled via RRC, for example.

The UE may receive from the gNB a configuration for DPD control signaling, including DPD configuration type, activation command format, periodic mode with indication period, aperiodic mode with trigger configuration details, etc. This may be signaled via RRC or MAC CE, for example.

The UE may receive from the gNB a configuration for DPD application, which may include during which transmission formats, channels, symbols, slots, etc., the UE should apply DPD, etc., e.g., during of one or more scheduled UL signals, e.g., Physical Uplink Shared Channel, PUSCHs, or during certain scheduling time intervals, e.g., specific slots or symbols, or for certain TX modes or formats (e.g. single-layer DFTS-OFDM transmission, or operation in FR2 or sub-THz frequency range). This may be signaled via RRC or MAC CE.

In one example, the UE receives a configuration or indication that it can operate in the NL part of PA in the UL and DPD is not required, or a reduced extent of DPD is sufficient, e.g., in case low-MCS signals or PUCCH-only signals are transmitted. The indication may directly or indirectly indicate a DPD mode, a DPD residual non-linearity, a modified EVM target, etc. that may be used for DPD configuration adaptation. The UE may additionally receive an indication that the gNB (or another UE in the SL) or other receivers apply DPOD and as such the UE is allowed to operate in the NL domain of PA (e.g., without DPD) when scheduled in the UL, reporting, e.g., channel qualities, or transmitting SRS, or reporting based on the received NLE-RS. As such then when the UE receives a scheduling for UL, e.g., SR, RACH, PUCCH, PUSCH, then it can operate in the NL domain and allow the receiver, e.g., gNB or another UE to take care of the distortions. For example, RRC signaling can be used to signal to the UE that, e.g., the gNB applies DPOD in reception, or that the actions the UE should take when scheduled with one or more specific UL channels. For example, specific actions may apply to PUSCH and PUCCH but not to RACH. The gNB may also indicate a target a residual response whose EVM is tolerable for the given transmission without further action, or to enable DPOD with a known function, e.g., a third-order polynomial, as the target output.

The UE may receive from the gNB a command according to the control signaling configuration to activate DPD, deactivate DPD, or modify DPD parameters, etc. This may be signaled via DCI or MAC CE.

The UE may signal to the gNB a list of DPD configurations and receive from the gNB a configuration or command for performing DPD, e.g. as an index to an entry in the list, etc. The list may be signaled via RRC, for example, and the command may be signaled via downlink control information (DCI), for example.

The UE may apply DPD to a transmitted signal based on the signaled and activated DPD configuration and DPD allocation configuration, e.g., applying a desired DPD response or DPD extent during configured times or configured signal transmission.

In some embodiments, the UE may be configured, e.g., as part of scheduling request (SR configuration), on which occasions it can apply DPD. The UE may also receive an indication, e.g., through a DCI, if it can apply DPD or not. In one example, if DCI schedules multiple PUCCHs or PUSCHs the indication is applicable to all, otherwise, it is indicated or configured otherwise.

In some embodiments, the UE receives an indication or configuration from the gNB on which beams it can apply DPD.

In some embodiments, the UE receives an indication or configuration if it should apply DPD to one or more RS transmissions, e.g., sounding reference signals (SRS).

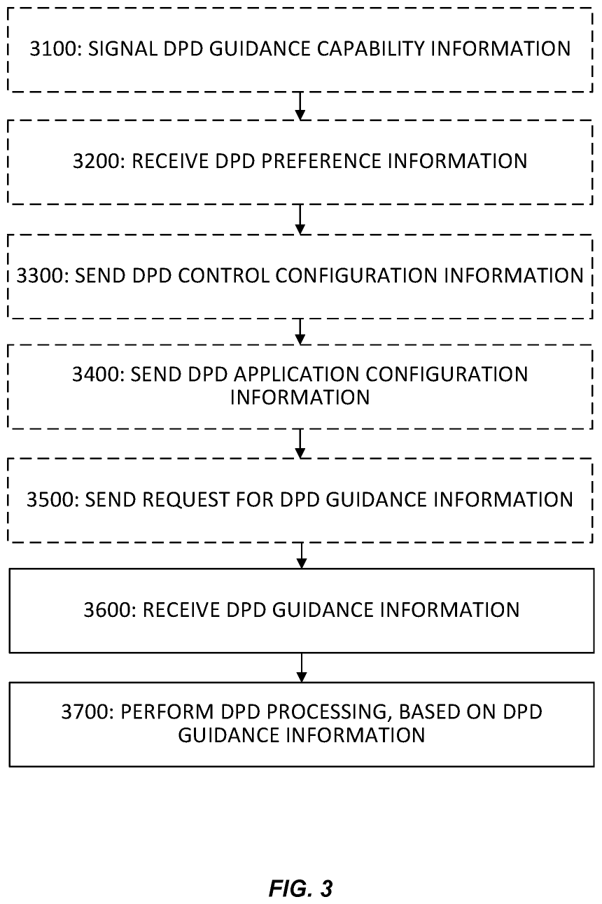

FIG. 3 is a process flow diagram illustrating one example of a method according to several of the techniques described above. It should be understood that the illustrated method is intended to generalize and to encompass many of the specific examples provided above. Thus, where the terminology used below to describe FIG. 3 differs from the terminology above, terms used below should be understood to at least encompass similar or clearly related/analogous terms used above.

The method shown in FIG. 3 is implemented in a first device, which may be, in various instances or embodiments, a UE or base station. The method comprises, as shown at block 3600, receiving, from a second device, digital-predistortion (DPD) guidance information, the DPD guidance information being indicative of whether and/or how, and/or to what extent to perform DPD processing at the first device. The method further comprises, as shown at block 3700, performing DPD processing at the first device, based on the DPD guidance information. In various embodiments or instances, this performing DPD processing may comprise adapting DPD processing at the first device, based on the DPD guidance information. This performing or adapting of the DPD processing may comprise activating or deactivating DPD operation, adapting DPD mode, adapting one or more DPD parameters, and/or adapting to which signal types, channels, time slots, and/or symbols DPD is applied.

In various embodiments or instances, the DPD guidance information comprises one or more of: a recommendation for DPD processing at the first device; an indication of whether to activate DPD processing at the first device; an indication of whether to change DPD functionality at the first device; an indication to change one or more DPD parameters; an indication or characteristic of residual non-linearity in a signal received at the second device; a metric of residual impairment to a signal received at the second device; and an index to a DPD configuration from among a plurality of predetermined DPD configurations. In some embodiments or instances, at least part of the DPD guidance information is frequency-band specific, such that the first device may receive additional guidance information for one or more additional frequency bands.

In some embodiments or instances, the DPD guidance information comprises a recommendation for DPD processing. This recommendation for DPD processing may indicate one or more of the following, for example: a transmission format to which DPD should be applied; a channel to which DPD should be applied; a symbol to which DPD should be applied; and a slot to which DPD should be applied.

In some embodiments or instances, the method may comprise signaling DPD guidance capability information to the second device, as shown at block 3100 of FIG. 3. The DPD guidance capability information may indicate support for one or more of the following, for example: one or more predetermined DPD configurations; a DPD activation indication; a DPD mode change indication; indications to change one or more DPD parameters; an indication or characteristic of residual non-linearity in a signal received at the second device; a metric of residual impairment to a signal received at the second device; and an index to a DPD configuration from among a plurality of predetermined DPD configurations. The received DPD guidance information may be in accordance with this DPD guidance capability information.

In some embodiments or instances, the method may comprise receiving DPD preference information from the second device, as shown at block 3200. This DPD preference information may indicate one or more of the following, for example: a preference for one or more predetermined DPD configurations; a preference for one or more DPD modes; and a desired or required maximum distortion level of transmitter output at the first device. The adapting of the DPD processing may be based on this DPD preference information, in some embodiments or instances.

In some embodiments or instances, the method may comprise sending DPD control configuration information to the second device. This is shown at block 3300. The DPD control configuration information may comprise one or more of the following, for example: an indication type for the DPD guidance information; a format for the DPD guidance information; an indication of periodic mode for DPD guidance, with an indication period; and an indication of aperiodic mode for DPD guidance, with an indication of a trigger for DPD guidance information; wherein receiving the DPD guidance information is performed in accordance with the DPD control configuration information. The received DPD guidance information may be in accordance with this DPD control configuration information.

In some embodiments or instances, the method may comprise sending DPD application configuration information to the second device. This is shown at block 3400. The DPD application configuration information may comprise one or more of the following, for example: an indication of a DPD mode; an indication of a residual non-linearity characteristic; and a residual impairment metric. In some embodiments, the method may comprise sending a plurality of DPD application configurations to the second device, each DPD application configuration comprising DPD application configuration information like that just described. In some of these embodiments or instances, the DPD guidance information received from the second device may include an index to one of the plurality of DPD application configurations and adapting DPD processing at the first device based on the DPD guidance information may comprise applying the DPD application configuration corresponding to the index.

In some embodiments or instances, the method may comprise sending a request for DPD guidance information to the second device. This is seen at block 3500 in FIG. 3. The DPD guidance information may be received in response to the request.

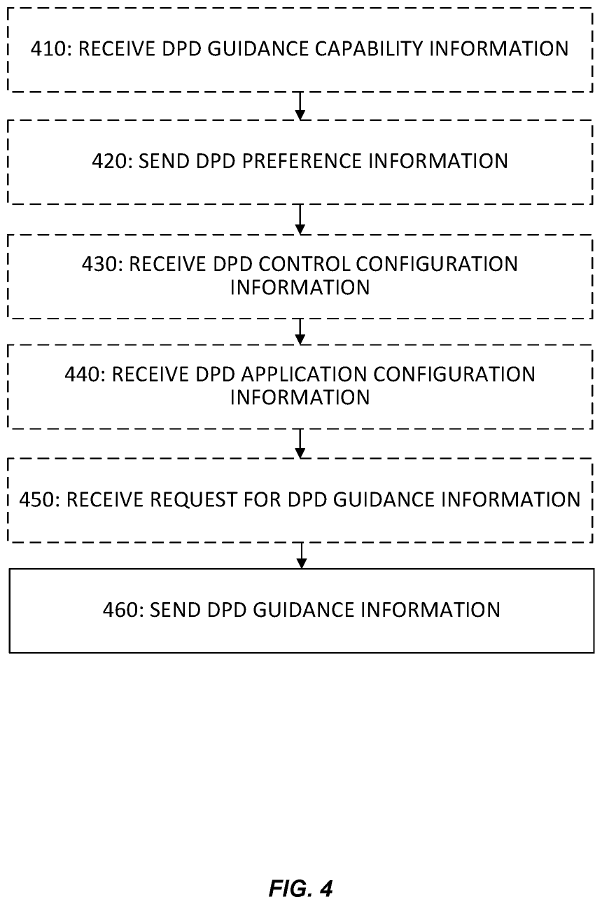

FIG. 4 illustrates another example method as might be performed by a first device. Again, the illustrated method is intended to generalize and to encompass many of the specific examples provided above. Thus, where the terminology used below to describe FIG. 4 differs from the terminology above, terms used below should be understood to at least encompass similar or clearly related/analogous terms used above.

The method shown in FIG. 4 is implemented in a first device, which may be, in various instances or embodiments, a UE or base station. The method comprises, as shown at block 460, sending, to a second device, digital-predistortion (DPD) guidance information, the DPD guidance information being indicative of whether and/or how and/or to what extent to perform DPD processing at the second device. The method may further comprise receiving a signal from the second device on which the second device has performed DPD processing based on the DPD guidance information.

In various embodiments or instances, the DPD guidance information comprises one or more of: a recommendation for DPD processing at the first device; an indication of whether to activate DPD processing at the first device; an indication of whether to change DPD functionality at the first device; an indication to change one or more DPD parameters; an indication or characteristic of residual non-linearity in a signal received at the second device; a metric of residual impairment to a signal received at the second device; and an index to a DPD configuration from among a plurality of predetermined DPD configurations. In some embodiments or instances, at least part of the DPD guidance information is frequency-band specific, such that the first device may send additional guidance information for one or more additional frequency bands.

In some embodiments or instances, the DPD guidance information comprises a recommendation for DPD processing. This recommendation for DPD processing may indicate one or more of the following, for example: a transmission format to which DPD should be applied; a channel to which DPD should be applied; a symbol to which DPD should be applied; and a slot to which DPD should be applied.

In some embodiments or instances, the method may comprise receiving DPD guidance capability information from the second device, as shown at block 410 of FIG. 4. The DPD guidance capability information may indicate support for one or more of the following, for example: one or more predetermined DPD configurations; a DPD activation indication; a DPD mode change indication; indications to change one or more DPD parameters; an indication or characteristic of residual non-linearity in a signal received at the second device; a metric of residual impairment to a signal received at the second device; and an index to a DPD configuration from among a plurality of predetermined DPD configurations. The sending of the DPD guidance information may be in accordance with this DPD guidance capability information.

In some embodiments or instances, the method may comprise sending DPD preference information to the second device, as shown at block 420. This DPD preference information may indicate one or more of the following, for example: a preference for one or more predetermined DPD configurations; a preference for one or more DPD modes; and a desired or required maximum distortion level of transmitter output at the first device. The adapting of the DPD processing at the second device may be based on this DPD preference information, in some embodiments or instances.

In some embodiments or instances, the method may comprise receiving DPD control configuration information from the second device. This is shown at block 430. The DPD control configuration information may comprise one or more of the following, for example: an indication type for the DPD guidance information; a format for the DPD guidance information; an indication of periodic mode for DPD guidance, with an indication period; and an indication of aperiodic mode for DPD guidance, with an indication of a trigger for DPD guidance information; wherein receiving the DPD guidance information is performed in accordance with the DPD control configuration information. The sending of the DPD guidance information may be in accordance with this DPD control configuration information.

In some embodiments or instances, the method may comprise receiving DPD application configuration information from the second device. This is shown at block 440. The DPD application configuration information may comprise one or more of the following, for example: an indication of a DPD mode; an indication of a residual non-linearity characteristic; and a residual impairment metric. In some embodiments, the method may comprise receiving a plurality of DPD application configurations to the second device, each DPD application configuration comprising DPD application configuration information like that just described. In some of these embodiments or instances, the DPD guidance information sent to the second device may include an index to one of the plurality of DPD application configurations.

In some embodiments or instances, the method may comprise receiving a request for DPD guidance information to the second device. This is seen at block 450 in FIG. 4. The DPD guidance information may be sent in response to the request.

In either of the methods shown in FIGS. 3 and 4, and in their variants, the first device may be a UE and the second device a base station, or the first device may be a base station and the second device a UE, or both devices may be UEs, in various embodiments or instances. In some systems, the devices at each end of a bi-directional communications link may be capable of performing DPD processing and may be configured to carry out both of the methods of FIGS. 3 and 4.

In view of the detailed examples and explanation provided above, it will be appreciated that the list below lists core aspects of some embodiments of the presently disclosed techniques, on the UE side, for the downlink and uplink, respectively. These aspects should be interpreted as being consistent with various examples given above.

### UE Actions in the DL

1. A method in a UE for guiding DPD processing [in gNB], the method comprising one or more of:
   signaling to a gNB a DPD guidance capability info,
   signaling to the gNB DPD preference info,
   receiving from the gNB a configuration for DPD control indication signaling,
   signaling to the gNB a recommendation for DPD application,
   signaling to the gNB a control indication/request according to the configuration,
   receiving from the gNB a list of DPD configurations/modes,
   signaling to the gNB an indication/request to perform DPD, comprising an index to an entry in the list.
2. + the guidance capability info comprises one or more of: support of preferred configuration indication, DPD activation indication, DPD mode/change indication, . . .
3. + the preference info comprises one or more of [longer-term] preferred DPD mode/configuration, desired/acceptable distortion level at TX output, . . .
4. + the configuration for control signaling comprises one or more of: indication type, indication message format, periodic mode with indication period, aperiodic mode with indication trigger definition, . . .
5. + the recommendation for DPD application comprises during which transmission formats, channels, symbols, slots, etc. the gNB could apply DPD.
6. + the control indication comprises one or more of [shorter-term] DPD mode indicator, to activate DPD, deactivate DPD, DPD parameter value, or modification to DPD parameters . . .
7. + the configurations in the list of DPD configurations comprise one or more of residual distortion function, residual distortion metric, . . .

### UE Actions in the UL

8. A method in a UE for performing DPD operation using assistance from a gNB, the method comprising one or more of:
   signaling to gNB a controlled DPD capability info,
   receiving from the gNB a DPD configuration,
   receiving from the gNB a configuration for DPD control signaling,
   receiving from the gNB a configuration for DPD application,
   receiving from the gNB a command according to the control signaling
   configuration to activate DPD, deactivate DPD, or modify DPD parameters,
   signaling to the gNB a list of DPD configurations,
   receiving from the gNB a configuration or command for performing DPD,
   comprising an index to an entry in the list,
   (applying DPD to a transmitted signal based on the selected DPD configuration and DPD allocation configuration).
9. + the controlled DPD capability info comprises one or more of support of receiving DPD configuration, DPD activation indication, DPD mode/change indication, . . .
10. + the DPD configuration comprises a DPD mode, a residual non-linear characteristic, a residual impairment metric, . . .
11. + the configuration for DPD control signaling comprises one or more of DPD configuration type, activation command format, periodic mode with indication period, aperiodic mode with trigger configuration details, . . .
12. + the configuration for DPD application comprises during which transmission formats, channels, symbols, slots, etc. the UE should apply DPD.

Note that gNB (base station) signaling steps for DL and UE are direct counterparts to the UE embodiments summarized immediately above.

Residual Non-Linearity Characteristic Info Provision from RX

The RX may assist the TX to adapt its DPD operation by providing information on NL characteristics (NLC) of the received signal. The RX exchange information about NLC estimation, reporting, and reception capability, NLC types and estimation types, reporting configurations, reporting activation indication, and related RS transmission. The RX may estimate the NL properties/characteristics using agreed configurations and report to the TX.

In some embodiments, the NL properties may be estimated using an embedded RS, NLE-RS. A NLE-RS may be transmitted to aid the RX in estimating the NL characteristic after the PA and/or the channel and other processing stages. The NLE-RS may be embedded in the transmitted signal and it will be subjected to NL effects similar to the rest of the signal. For example, an NLE-RS may be inserted in reserved symbols or parts of symbols (sample subsets). The NLE-RS may consist of sample groups with different predetermined magnitudes, so that the NL mapping from TX input to PA output may be characterized at the RX. Alternatively, a corresponding RS may be inserted in the F-domain and mapped to distinct T-domain samples. Such an RS can also be transmitted prior to or after a signal, or a group of signals. In some embodiments, the NLE-RS may be transmitted separately from data/control signals but with PA and other transmitter settings configured to match the settings during the transmissions of those signals.

The TX and RX may exchange signaling to control NLE-RS transmission: to configure one or more parameters of the RS, to request, and to indicate the transmission. The RS activation may be periodic or aperiodic.

In some embodiments, the NLE-RS characteristics may change per transmission occasion and the information about the characteristics is provided to the RX. In a DL example, in a first occasion (e.g., a first slot), a portion of the data (e.g., PDSCH) is amplified to a distorted level, and the NLE-RS in that occasion is transmitted with such power and/or structure that the RX can estimate the relevant distortion. Then, in the next transmission occasion (e.g., the next slot) the PA may be operating predominantly in the linear area, and the NLE-RS output power may be adopted so that it is suitably scaled for estimating the relevant distortion region for this occasion. The UE may be dynamically informed, e.g., in a non-distorted PDCCH downlink control information (DCI), about the NLE-RS characteristics (in the example above the absolute or delta dB level variations) per transmission occasion.

In other embodiments, the NL properties may be estimated without an embedded RS, e.g., based on other received signal properties like total received signal magnitude distribution.

The NL properties can also be characterized by intentionally creating an absence of signal in a certain frequency range, while transmitting regular signals in the rest of the signal bandwidth. The frequency range where no intentional signal is transmitted will then carry intermodulation distortion and noise. By comparing the signal in this range to corresponding calculated intermodulation distortion of the signal, the NL properties of the transmitter can be estimated. Leaving empty of a number of sub-carriers can thus be an alternative to transmitting an explicit RS signal. Which sub-carriers to use for this purpose must be communicated between the nodes, similar to agreeing on RS parameters.

In some embodiments, the NLC may constitute a single metric, e.g., EVM or a cubic metric.

In other embodiments, the NLC may constitute a characterizing function reflecting the non-linear input-output relationship for different input magnitudes. Such function may be formulated non-parametrically, e.g., via a set of output magnitude values for a set of input magnitudes, or parametrically, e.g., parameter values for, e.g., a third-order polynomial or another function that sufficiently closely describes the non-linearity.

With respect to DPD processing for the downlink (DL), the UE in the DL may estimate the NLC of the received signal and inform the gNB about its output NL properties in order to assist in gNB DPD adaptation, to minimize related gNB processing load and/or power consumption while maintaining the required received signal quality.

The UE may signal to the gNB NLC reporting capability info, including support of NLE-RS reception capability, NLC estimation as composite metric or NL function, NLC estimation from NLE-RS, NLC reporting constraints, periodic/aperiodic capability, etc. This may be signaled via the capability reporting framework during the NW attachment procedure or via other RRC signaling. The capability indication may be frequency band specific.

In some embodiments, the NLC reporting capability may be dynamic and may depend on the UE energy status or other ongoing processing, and may be reported using dynamic methods, e.g., MAC CE or UCI, including indicating one of preconfigured options as being currently in effect. The list of preconfigured options may be provided by the UE in the above capability reporting or RRC signaling, or by the gNB via RRC signaling.

The UE may receive from the gNB NLC reporting configuration, including report type, report message format, periodic mode with reporting period, aperiodic mode with reporting trigger definition, etc. This may be signaled, e.g., via RRC.

The UE may receive from the gNB NLC reporting activation indication, e.g., an indication that a one-time report or a periodic report should be transmitted. This may be signaled, e.g., via DCI or MAC CE.

The UE may transmit to the gNB a preference or a request for NLE-RS transmission for NL estimation. The preference may contain an indication that the RS should be transmitted, and optionally the preferred configuration, e.g., transmission rate or magnitude resolution. The preference may be provided via the UE assistance information (UAI) framework. Alternatively, the UE may transmit to the gNB a preference or a request for a NLE measurement region.

The UE may receive from the gNB the NLE-RS configuration, e.g., RS format, type, or mode, RS transmission resources and parameters (T/F/code/seeds, scaling), temporal pattern (period, or aperiodic, in which time instants), together with which transmitted signals, transmission formats with which the RS is transmitted, etc. The configuration may also indicate that a NLE-RS will be transmitted prior to/after the scheduled DL signal, or as independent RS. This may be signaled, e.g., via RRC.

The UE may receive from the gNB other NLE configuration, e.g., frequency gap info (location, width) for non-linearity estimation, e.g., IMD or other spectral widening or signal leakage power estimation. The UE may use this region for NL estimation.

The UE may receive from the gNB the transmitted NLE-RS according to the NLE-RS configuration and estimate the NLC using the RS. Alternatively, the UE may estimate the NLC based on the total received signal without using a specific RS.

The UE may signal to the gNB a NLC report based on the reporting configuration and7or reporting activation indications, containing the estimated NLC information. This may be signaled, e.g., via UCI or using a data container in PUSCH.

The UE may also receive from the gNB via RRC multiple NLE-RS configuration, other NLE configurations, and report configurations, to be applied in different specified scenarios (e.g., in conjunction with different transmission modes or configurations). The UE may select the instantaneously valid mode, e.g., based on selection criteria received via RRC or based on L1/2 indications, e.g., DCI or MAC CE.

With respect to DPD processing for the uplink (UL), the UE in the UL may receive estimated NLC from the received signal at the gNB in order to assist in UE DPD adaptation, to minimize related gNB processing load and/or power consumption while maintaining the required received signal quality.

The UE may signal to the gNB NLC reception capability info, e.g., support of NLE-RS transmission capability, NLC as composite metric, NLC estimated from NLE-RS, NLC reception ability, etc. This may be signaled via the capability reporting framework during the NW attachment procedure or via other RRC signaling. The capability indication may be frequency band specific.

The UE may signal to the gNB NLC reception preference info, e.g., preferred NLC report type, periodic/aperiodic, etc. This may be signaled, e.g., via the UAI framework or via other RRC signaling.

The UE may receive from the gNB a NLC report configuration, e.g., report type, report message format, periodic mode with reporting period, aperiodic mode with reporting trigger definition, etc. This may be signaled, e.g., via RRC.

The UE may signal to the gNB NLC report request info, e.g., comprises a request to transmit a one-time report, to start periodic reporting, etc. This may be signaled, e.g., via UCI.

The UE may receive from the gNB NLC report activation indication, e.g., an indication that a one-time report or a periodic report is being transmitted, etc. This may be signaled, e.g., via RRC or MAC CE.

The UE may receive from the gNB the NLE-RS configuration, e.g., RS format, RS transmission resources and parameters (T/F/code, scaling), in which time instants, periodic (with given period) or aperiodic, together with which transmitted signals, transmission formats with which the RS is to be transmitted, etc. This may be signaled, e.g., via RRC.

The UE may receive from the gNB other NLE configuration, e.g., frequency gap info (time and frequency location, width) for non-linearity estimation, e.g., IMD or other spectral widening or signal leakage power estimation. The UE then leaves the specified gap resources empty so the gNB can use this region for NL estimation.

The UE may transmit to the gNB a NLE-RS according to the NLE-RS configuration.

The UE may receive from the gNB a NLC report, and adapt its DPD configuration based on the report. The report may be signaled, e.g., via MAC CE.

The UE may also receive from the gNB via RRC multiple NLE-RS configuration, other NLE configurations, and report configurations, to be applied in different specified scenarios (e.g., in conjunction with different transmission modes or configurations). The UE may select the instantaneously valid mode, e.g., based on selection criteria received via RRC or based on L1/2 indications, e.g., DCI or MAC CE.

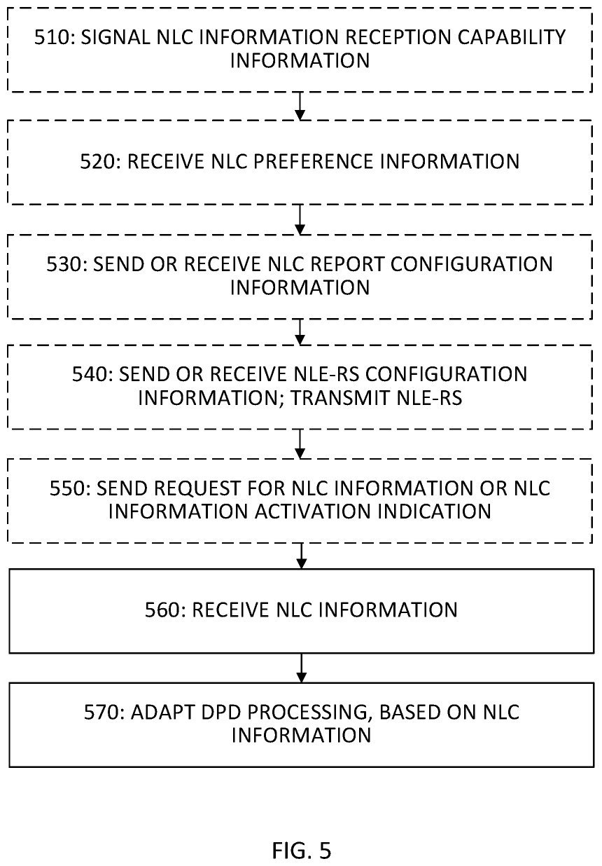

FIG. 5 is a process flow diagram illustrating one example of a method according to several of the techniques described above. It should be understood that the illustrated method is intended to generalize and to encompass many of the specific examples provided above. Thus, where the terminology used below to describe FIG. 5 differs from the terminology above, terms used below should be understood to at least encompass similar or clearly related/analogous terms used above.

The method shown in FIG. 5 is implemented in a first device, which may be, in various instances or embodiments, a UE or base station. The method comprises, as shown at block 560, receiving, from a second device, non-linearity characteristic (NLC) information, the NLC information indicating a characteristic of and/or an extent of and/or a type of non-linearity in a signal received at the second device. The method further comprises, as shown at block 570, adapting DPD processing at the first device, based on the NLC information. This adapting of DPD processing may comprise, in various embodiments or instances, one or more of: activating or deactivating DPD operation; adapting DPD mode; adapting one or more DPD parameters; and adapting to which signal types, channels, time slots, and/or symbols DPD is applied.

In some embodiments or instances, the NLC information comprises one or more of the following, for the signal received at the second device: an error vector magnitude (EVM) metric; a cubic metric; and an indication of a characterizing function. In some embodiments or instances, at least part of the NL information is frequency-band specific. The NLC information may include an indication of a part of the received signal to which the NLC information applies.

In some embodiments or instances, the method may comprise signaling NLC information reception capability information to the second device, as shown at block 510 in FIG. 5. In some embodiments or instances, the NLC information reception capability information may indicate support for one or more of the following, for example: non-linearity estimation reference signal (NLE-RS) transmission; NLC as a composite metric; NLC estimated from NLE-RS; NLC information reception ability.

In some embodiments or instances, the method may comprise receiving NLC preference information from the second device. This is shown at block 520. the NLC preference information may indicate one or more of the following, for example: a preferred NLC report type; a preference for periodic or aperiodic NLC information reporting; and a periodicity for NLC information reporting.

In some embodiments or instances, the method may comprise receiving NLC report configuration information from the second device. Alternatively, in some embodiments or instances the first device may control the report configuration, in which case the method may comprise sending NLC report configuration information to the second device. These alternatives are shown at block 530 in FIG. 5. In either case, the NLC report configuration information may comprise one or more of the following, for example: an indication of a NLC report type; an indication of an NLC report format; an indication of an NLC report periodicity; an indication of trigger for aperiodic reporting. The receiving of the NLC information may be performed in accordance with the NLC report configuration information.

In some embodiments or instances, the method may comprise receiving non-linearity estimation reference signal (NLE-RS) configuration information from the second device. Alternatively, in some embodiments or instances the first device may control the NLE-RS configuration, in which case the method may comprise sending NLE-RS configuration information to the second device. These alternatives are shown at block 540. In either case, the NLE-RS configuration information may comprise one or more of the following, for example: an indication of NLE-RS format; an indication of NLE-RS transmission resources; an indication of one or more NLE-RS parameters; an indication of time intervals for NLE-RS transmission; an indication of a transmission format for NLE-RS transmission; and an indication of frequency gap information for non-linearity estimation. The method may further comprise transmitting NLE-RS according to the NLE-RS configuration information. Note that the indication of frequency gap information for non-linearity estimation need not necessarily relate to NLE-RS-in some embodiments or instances, this configuration information may be sent or received separately, on its own or along with other configuration information for non-linearity estimation.

In some embodiments, the method may comprise sending a request for NLC information to the second device, where the NLC information is received in response to the request. Alternatively, the method may comprise sending an NLC information activation indication to the second device, where the NLC information is received in response to the NLC information activation indication. Both of these alternatives are shown at block 550. The NLC information activation indication may include, for example, an indication of whether a one-time NLC information report or periodic NLC information reports should be transmitted.

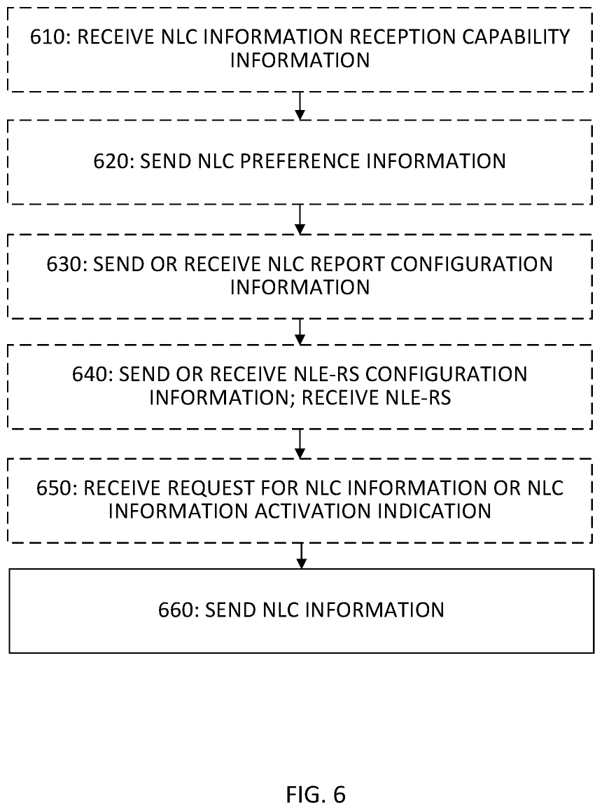

FIG. 6 illustrates another example method as might be performed by a first device. Again, the illustrated method is intended to generalize and to encompass many of the specific examples provided above. Thus, where the terminology used below to describe FIG. 6 differs from the terminology above, terms used below should be understood to at least encompass similar or clearly related/analogous terms used above.

The method shown in FIG. 6 is implemented in a first device, which may be, in various instances or embodiments, a UE or base station. The method comprises, as shown at block at block 660, sending, to a second device, non-linearity characteristic (NLC) information, the NLC information indicating a characteristic of and/or an extent of and/or a type of non-linearity in a signal received at the first device.

In some embodiments or instances, the NLC information comprises one or more of the following, for the signal received at the second device: an error vector magnitude (EVM) metric; a cubic metric; and an indication of a characterizing function. In some embodiments or instances, at least part of the NL information is frequency-band specific. The NLC information may include an indication of a part of the received signal to which the NLC information applies.

In some embodiments or instances, the method may comprise receiving NLC information reception capability information from the second device, as shown at block 610 in FIG. 6. In some embodiments or instances, the NLC information reception capability information may indicate support for one or more of the following, for example: non-linearity estimation reference signal (NLE-RS) transmission; NLC as a composite metric; NLC estimated from NLE-RS; NLC information reception ability.

In some embodiments or instances, the method may comprise sending NLC preference information to the second device. This is shown at block 620. The NLC preference information may indicate one or more of the following, for example: a preferred NLC report type; a preference for periodic or aperiodic NLC information reporting; and a periodicity for NLC information reporting.

In some embodiments or instances, the method may comprise sending NLC report configuration information to the second device. Alternatively, in some embodiments or instances the second device may control the report configuration, in which case the method may comprise receiving NLC report configuration information from the second device. These alternatives are shown at block 630 in FIG. 6. In either case, the NLC report configuration information may comprise one or more of the following, for example: an indication of a NLC report type; an indication of an NLC report format; an indication of an NLC report periodicity; an indication of trigger for aperiodic reporting. The sending of the NLC information may be performed in accordance with the NLC report configuration information.

In some embodiments or instances, the method may comprise sending non-linearity estimation reference signal (NLE-RS) configuration information to the second device. Alternatively, in some embodiments or instances the first device may control the NLE-RS configuration, in which case the method may comprise receiving NLE-RS configuration information from the second device. These alternatives are shown at block 640. In either case, the NLE-RS configuration information may comprise one or more of the following, for example: an indication of NLE-RS format; an indication of NLE-RS transmission resources; an indication of one or more NLE-RS parameters; an indication of time intervals for NLE-RS transmission; an indication of a transmission format for NLE-RS transmission; and an indication of frequency gap information for non-linearity estimation. The method may further comprise receiving NLE-RS according to the NLE-RS configuration information, and estimating one or more non-linearity characteristics or metrics, using the NLE-RS. Note that the indication of frequency gap information for non-linearity estimation need not necessarily relate to NLE-RS—in some embodiments or instances, this configuration information may be sent or received separately, on its own or along with other configuration information for non-linearity estimation.

In some embodiments, the method may comprise receiving a request for NLC information to the second device, where the NLC information is sent in response to the request.

Alternatively, the method may comprise receiving an NLC information activation indication to the second device, where the NLC information is sent in response to the NLC information activation indication. Both of these alternatives are shown at block 650. The NLC information activation indication may include, for example, an indication of whether a one-time NLC information report or periodic NLC information reports should be transmitted.

A device may be capable of both performing DPD and sending NLC information for supporting DPD at another device. In such cases, the method illustrated in FIG. 6 might be implemented in a device that also implements a method according to FIG. 5. Alternatively or additionally, the method shown in FIG. 6 might be implemented in a device at the other end of the signaling shown in FIG. 5, such that the method of FIG. 6 at least partly complements that of FIG. 5.

In any of the methods shown in FIGS. 5 and 6 and described above, the first device may be a UE and the second device a base station, or the first device may be a base station and the second device a UE, or both devices may be UEs, in various embodiments or instances.

In view of the detailed examples and explanation provided above, it will be appreciated that the list below lists core aspects of some embodiments of the presently disclosed techniques, on the UE side, for the downlink and uplink, respectively.

### UE Actions in the DL

1. A method in a UE for non-linearity characteristic (NLC) provision [to support DPD in a gNB], the method comprising one or more of:
   signaling to the gNB NLC reporting capability info,
   receiving from the gNB NLC reporting configuration,
   receiving from the gNB NLC reporting activation indications,
   receiving from the gNB the NLE-RS configuration or other NLE configuration,
   receiving from the gNB the transmitted NLE-RS according to the NLE-RS configuration,
   (estimating the NLC),
   signaling to the gNB a NLC report.
2. + the NLC reporting capability info comprises support one or more of: NLE-RS reception capability, NLC estimation as composite metric or NL function, NLC estimation from NLE-RS, NLC reporting constraints, . . .
3. + the NLC reporting configuration comprises one or more of: report type, report message format, periodic mode with reporting period, aperiodic mode with reporting trigger definition, . . .
4. + the NLE-RS configuration info comprises one or more of RS format, RS transmission resources and parameters (T/F/code, scaling), in which time instants, together with which transmitted signals, transmission formats with which the RS is transmitted, . . .
5. + other NLE configuration may comprise frequency gap info (location, width) for non-linearity estimation, e.g. IMD or other spectral widening or signal leakage power estimation.
6. + the reporting activation indication comprises one or more of: an indication that a one-time report or a periodic report should be transmitted.

### UE Actions in the UL

7. A method in a UE for obtaining non-linearity characteristic (NLC) info for DPD adaptation, the method comprising one or more of:
   signaling to the gNB NLC reception capability info,
   signaling to the gNB NLC reception preference info,
   receiving from the gNB a NLC report configuration,
   signaling to the gNB NLC report request info,
   receiving from the gNB a NLC report activation indication,
   receiving from the gNB the NLE-RS configuration or other NLE configuration,
   transmitting to the gNB a NLE-RS according to the NLE-RS configuration,
   receiving from the gNB a NLC report,
   (adapting DPD configuration based on the report).
8. + the NLC reception capability info comprises support one or more of: NLE-RS transmission capability, NLC as composite metric, NLC estimated from NLE-RS, NLC reception ability, . . .
9. + the preference info comprises one or more of preferred NLC report type, periodic/aperiodic, . . .
10. + the NLC report configuration comprises one or more of: report type, report message format, periodic mode with reporting period, aperiodic mode with reporting trigger definition,
11. + the NLC report request info comprises a request to transmit a one-time report, to start periodic reporting, . . .
12. + the reporting activation indication comprises one or more of: an indication that a one-time report or a periodic report is being transmitted.
13. + the NLE-RS configuration info comprises one or more of RS format, RS transmission resources and parameters (T/F/code, scaling), in which time instants, together with which transmitted signals, transmission formats with which the RS is transmitted, . . .
14. + other NLE configuration may comprise frequency gap info (frequency location, width) for non-linearity estimation.

Note that gNB (base station) signaling steps for DL and UE are direct counterparts to the UE embodiments summarized immediately above.

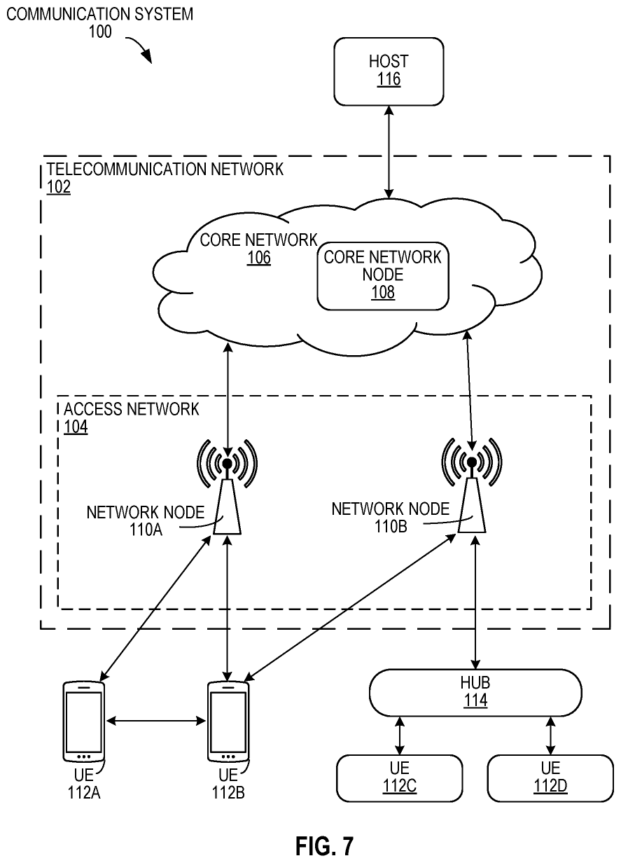

FIG. 7 shows an example of a communication system 100 in accordance with some embodiments. The techniques and apparatuses described above may be implemented in such a system, or variations thereof. In this example, the communication system 100 includes a telecommunication network 102 that includes an access network 104, such as a radio access network (RAN), and a core network 106, which includes one or more core network nodes 108. The access network 104 includes one or more access network nodes, such as network nodes 110a and 110b (one or more of which may be generally referred to as network nodes 110), or any other similar 3rd Generation Partnership Project (3GPP) access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network 102 includes one or more Open-RAN (ORAN) network nodes. An ORAN network node is a node in the telecommunication network 102 that supports an ORAN specification (e.g., a specification published by the O-RAN Alliance, or any similar organization) and may operate alone or together with other nodes to implement one or more functionalities of any node in the telecommunication network 102, including one or more network nodes 110 and/or core network nodes 108.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes 110 facilitate direct or indirect connection of user equipment (UE), such as by connecting UEs 112a, 112b, 112c, and 112d (one or more of which may be generally referred to as UEs 112) to the core network 106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 100 may include any number of wired or wireless networks, network nodes, UEs, and/or any other components or systems that may facilitate or participate in the communication of data and/or signals whether via wired or wireless connections. The communication system 100 may include and/or interface with any type of communication, telecommunication, data, cellular, radio network, and/or other similar type of system.

The UEs 112 may be any of a wide variety of communication devices, including wireless devices arranged, configured, and/or operable to communicate wirelessly with the network nodes 110 and other communication devices. Similarly, the network nodes 110 are arranged, capable, configured, and/or operable to communicate directly or indirectly with the UEs 112 and/or with other network nodes or equipment in the telecommunication network 102 to enable and/or provide network access, such as wireless network access, and/or to perform other functions, such as administration in the telecommunication network 102.

In the depicted example, the core network 106 connects the network nodes 110 to one or more hosts, such as host 116. These connections may be direct or indirect via one or more intermediary networks or devices. In other examples, network nodes may be directly coupled to hosts. The core network 106 includes one more core network nodes (e.g., core network node 108) that are structured with hardware and software components. Features of these components may be substantially similar to those described with respect to the UEs, network nodes, and/or hosts, such that the descriptions thereof are generally applicable to the corresponding components of the core network node 108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 116 may be under the ownership or control of a service provider other than an operator or provider of the access network 104 and/or the telecommunication network 102, and may be operated by the service provider or on behalf of the service provider. The host 116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 100 of FIG. 7 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 102 is a cellular network that implements 3GPP standardized features. Accordingly, the telecommunications network 102 may support network slicing to provide different logical networks to different devices that are connected to the telecommunication network 102. For example, the telecommunications network 102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 112 are configured to transmit and/or receive information without direct human interaction. For instance, a UE may be designed to transmit information to the access network 104 on a predetermined schedule, when triggered by an internal or external event, or in response to requests from the access network 104. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 114 communicates with the access network 104 to facilitate indirect communication between one or more UEs (e.g., UE 112c and/or 112d) and network nodes (e.g., network node 110b). In some examples, the hub 114 may be a controller, router, content source and analytics, or any of the other communication devices described herein regarding UEs. For example, the hub 114 may be a broadband router enabling access to the core network 106 for the UEs. As another example, the hub 114 may be a controller that sends commands or instructions to one or more actuators in the UEs. Commands or instructions may be received from the UEs, network nodes 110, or by executable code, script, process, or other instructions in the hub 114. As another example, the hub 114 may be a data collector that acts as temporary storage for UE data and, in some embodiments, may perform analysis or other processing of the data. As another example, the hub 114 may be a content source. For example, for a UE that is a VR headset, display, loudspeaker or other media delivery device, the hub 114 may retrieve VR assets, video, audio, or other media or data related to sensory information via a network node, which the hub 114 then provides to the UE either directly, after performing local processing, and/or after adding additional local content. In still another example, the hub 114 acts as a proxy server or orchestrator for the UEs, in particular if one or more of the UEs are low energy IoT devices.

The hub 114 may have a constant/persistent or intermittent connection to the network node 110b. The hub 114 may also allow for a different communication scheme and/or schedule between the hub 114 and UEs (e.g., UE 112c and/or 112d), and between the hub 114 and the core network 106. In other examples, the hub 114 is connected to the core network 106 and/or one or more UEs via a wired connection. Moreover, the hub 114 may be configured to connect to an M2M service provider over the access network 104 and/or to another UE over a direct connection. In some scenarios, UEs may establish a wireless connection with the network nodes 110 while still connected via the hub 114 via a wired or wireless connection. In some embodiments, the hub 114 may be a dedicated hub-that is, a hub whose primary function is to route communications to/from the UEs from/to the network node 110b. In other embodiments, the hub 114 may be a non-dedicated hub-that is, a device which is capable of operating to route communications between the UEs and network node 110b, but which is additionally capable of operating as a communication start and/or end point for certain data channels.

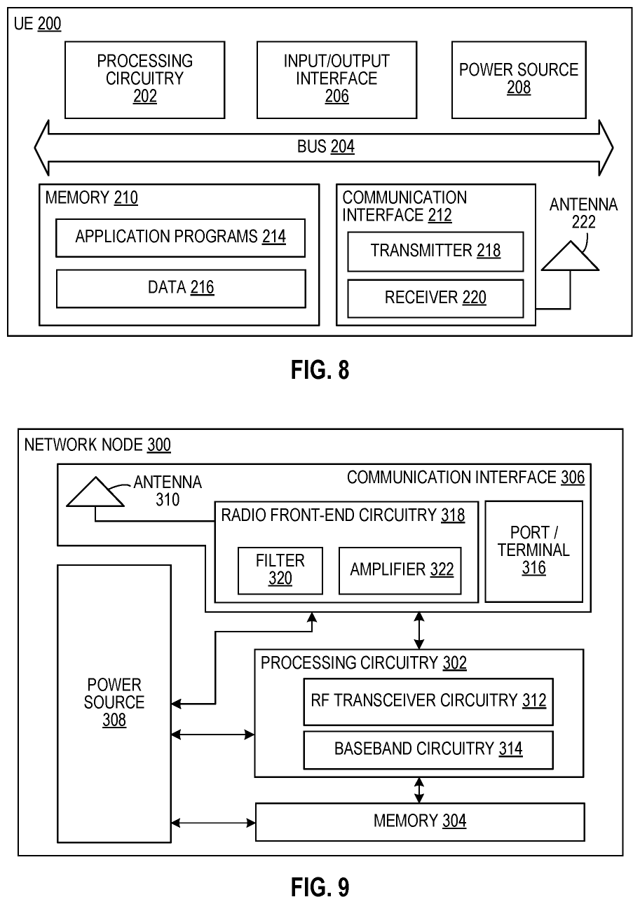

FIG. 8 shows a UE 200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 200 includes processing circuitry 202 that is operatively coupled via a bus 204 to an input/output interface 206, a power source 208, a memory 210, a communication interface 212, and/or any other component, or any combination thereof. Certain UEs may utilize all or a subset of the components shown in FIG. 10. The level of integration between the components may vary from one UE to another UE. Further, certain UEs may contain multiple instances of a component, such as multiple processors, memories, transceivers, transmitters, receivers, etc.

The processing circuitry 202 is configured to process instructions and data and may be configured to implement any sequential state machine operative to execute instructions stored as machine-readable computer programs in the memory 210. The processing circuitry 202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 202 may include multiple central processing units (CPUs).

In the example, the input/output interface 206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 208 is structured as a battery or battery pack. Other types of power sources, such as an external power source (e.g., an electricity outlet), photovoltaic device, or power cell, may be used. The power source 208 may further include power circuitry for delivering power from the power source 208 itself, and/or an external power source, to the various parts of the UE 200 via input circuitry or an interface such as an electrical power cable. Delivering power may be, for example, for charging of the power source 208. Power circuitry may perform any formatting, converting, or other modification to the power from the power source 208 to make the power suitable for the respective components of the UE 200 to which power is supplied.

The memory 210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 210 includes one or more application programs 214, such as an operating system, web browser application, a widget, gadget engine, or other application, and corresponding data 216. The memory 210 may store, for use by the UE 200, any of a variety of various operating systems or combinations of operating systems.

The memory 210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 210 may allow the UE 200 to access instructions, application programs and the like, stored on transitory or non-transitory memory media, to off-load data, or to upload data. An article of manufacture, such as one utilizing a communication system may be tangibly embodied as or in the memory 210, which may be or comprise a device-readable storage medium.

The processing circuitry 202 may be configured to communicate with an access network or other network using the communication interface 212. The communication interface 212 may comprise one or more communication subsystems and may include or be communicatively coupled to an antenna 222. The communication interface 212 may include one or more transceivers used to communicate, such as by communicating with one or more remote transceivers of another device capable of wireless communication (e.g., another UE or a network node in an access network). Each transceiver may include a transmitter 218 and/or a receiver 220 appropriate to provide network communications (e.g., optical, electrical, frequency allocations, and so forth). Moreover, the transmitter 218 and receiver 220 may be coupled to one or more antennas (e.g., antenna 222) and may share circuit components, software or firmware, or alternatively be implemented separately.

In the illustrated embodiment, communication functions of the communication interface 212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IOT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 200 shown in FIG. 8.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 9 shows a network node 300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 300 includes a processing circuitry 302, a memory 304, a communication interface 306, and a power source 308. The network node 300 may be composed of multiple physically separate components (e.g., a NodeB component and a RNC component, or a BTS component and a BSC component, etc.), which may each have their own respective components. In certain scenarios in which the network node 300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 300 may be configured to support multiple radio access technologies (RATs). In such embodiments, some components may be duplicated (e.g., separate memory 304 for different RATs) and some components may be reused (e.g., a same antenna 310 may be shared by different RATs). The network node 300 may also include multiple sets of the various illustrated components for different wireless technologies integrated into network node 300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 300.

The processing circuitry 302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 300 components, such as the memory 304, to provide network node 300 functionality.

In some embodiments, the processing circuitry 302 includes a system on a chip (SOC). In some embodiments, the processing circuitry 302 includes one or more of radio frequency (RF) transceiver circuitry 312 and baseband processing circuitry 314. In some embodiments, the radio frequency (RF) transceiver circuitry 312 and the baseband processing circuitry 314 may be on separate chips (or sets of chips), boards, or units, such as radio units and digital units. In alternative embodiments, part or all of RF transceiver circuitry 312 and baseband processing circuitry 314 may be on the same chip or set of chips, boards, or units.

The memory 304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 302. The memory 304 may store any suitable instructions, data, or information, including a computer program, software, an application including one or more of logic, rules, code, tables, and/or other instructions capable of being executed by the processing circuitry 302 and utilized by the network node 300. The memory 304 may be used to store any calculations made by the processing circuitry 302 and/or any data received via the communication interface 306. In some embodiments, the processing circuitry 302 and memory 304 is integrated.

The communication interface 306 is used in wired or wireless communication of signaling and/or data between a network node, access network, and/or UE. As illustrated, the communication interface 306 comprises port(s)/terminal(s) 316 to send and receive data, for example to and from a network over a wired connection. The communication interface 306 also includes radio front-end circuitry 318 that may be coupled to, or in certain embodiments a part of, the antenna 310. Radio front-end circuitry 318 comprises filters 320 and amplifiers 322. The radio front-end circuitry 318 may be connected to an antenna 310 and processing circuitry 302. The radio front-end circuitry may be configured to condition signals communicated between antenna 310 and processing circuitry 302. The radio front-end circuitry 318 may receive digital data that is to be sent out to other network nodes or UEs via a wireless connection. The radio front-end circuitry 318 may convert the digital data into a radio signal having the appropriate channel and bandwidth parameters using a combination of filters 320 and/or amplifiers 322. The radio signal may then be transmitted via the antenna 310. Similarly, when receiving data, the antenna 310 may collect radio signals which are then converted into digital data by the radio front-end circuitry 318. The digital data may be passed to the processing circuitry 302. In other embodiments, the communication interface may comprise different components and/or different combinations of components.

In certain alternative embodiments, the network node 300 does not include separate radio front-end circuitry 318, instead, the processing circuitry 302 includes radio front-end circuitry and is connected to the antenna 310. Similarly, in some embodiments, all or some of the RF transceiver circuitry 312 is part of the communication interface 306. In still other embodiments, the communication interface 306 includes one or more ports or terminals 316, the radio front-end circuitry 318, and the RF transceiver circuitry 312, as part of a radio unit (not shown), and the communication interface 306 communicates with the baseband processing circuitry 314, which is part of a digital unit (not shown).

The antenna 310 may include one or more antennas, or antenna arrays, configured to send and/or receive wireless signals. The antenna 310 may be coupled to the radio front-end circuitry 318 and may be any type of antenna capable of transmitting and receiving data and/or signals wirelessly. In certain embodiments, the antenna 310 is separate from the network node 300 and connectable to the network node 300 through an interface or port.

The antenna 310, communication interface 306, and/or the processing circuitry 302 may be configured to perform any receiving operations and/or certain obtaining operations described herein as being performed by the network node. Any information, data and/or signals may be received from a UE, another network node and/or any other network equipment. Similarly, the antenna 310, the communication interface 306, and/or the processing circuitry 302 may be configured to perform any transmitting operations described herein as being performed by the network node. Any information, data and/or signals may be transmitted to a UE, another network node and/or any other network equipment.

The power source 308 provides power to the various components of network node 300 in a form suitable for the respective components (e.g., at a voltage and current level needed for each respective component). The power source 308 may further comprise, or be coupled to, power management circuitry to supply the components of the network node 300 with power for performing the functionality described herein. For example, the network node 300 may be connectable to an external power source (e.g., the power grid, an electricity outlet) via an input circuitry or interface such as an electrical cable, whereby the external power source supplies power to power circuitry of the power source 308. As a further example, the power source 308 may comprise a source of power in the form of a battery or battery pack which is connected to, or integrated in, power circuitry. The battery may provide backup power should the external power source fail.

Embodiments of the network node 300 may include additional components beyond those shown in FIG. 9 for providing certain aspects of the network node's functionality, including any of the functionality described herein and/or any functionality necessary to support the subject matter described herein. For example, the network node 300 may include user interface equipment to allow input of information into the network node 300 and to allow output of information from the network node 300. This may allow a user to perform diagnostic, maintenance, repair, and other administrative functions for the network node 300.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

1-28. (canceled)

29. A method, in a first device, the method comprising:
receiving, from a second device, digital-predistortion (DPD) guidance information, the DPD guidance information being indicative of whether and/or how, and/or to what extent to perform DPD processing at the first device; and
performing DPD processing at the first device, based on the DPD guidance information.

30. The method of claim 29, wherein the DPD guidance information comprises one or more of:
a recommendation for DPD processing at the first device;
an indication of whether to activate DPD processing at the first device;
an indication of whether to change DPD functionality at the first device;
an indication to change one or more DPD parameters;
an indication or characteristic of residual non-linearity in a signal received at the second device;
a metric of residual impairment to a signal received at the second device; and
an index to a DPD configuration from among a plurality of predetermined DPD configurations.

31. The method of claim 29, wherein at least part of the DPD guidance information is frequency-band specific.

32. The method of claim 29, wherein the DPD guidance information comprises a recommendation for DPD processing, the recommendation for DPD processing indicating one or more of:
a transmission format to which DPD should be applied;
a channel to which DPD should be applied;
a symbol to which DPD should be applied; and
a slot to which DPD should be applied.

33. The method of claim 29, further comprising:
signaling DPD guidance capability information to the second device, the DPD guidance capability information indicating support for one or more of:
one or more predetermined DPD configurations;
a DPD activation indication;
a DPD mode change indication;
indications to change one or more DPD parameters;
an indication or characteristic of residual non-linearity in a signal received at the second device;
a metric of residual impairment to a signal received at the second device; and
an index to a DPD configuration from among a plurality of predetermined DPD configurations.

34. The method of claim 29, further comprising:
receiving DPD preference information from the second device, the DPD preference information indicating one or more of:
a preference for one or more predetermined DPD configurations;
a preference for one or more DPD modes; and
a desired or required maximum distortion level of transmitter output at the first device.

35. The method of claim 29, further comprising:
sending DPD control configuration information to the second device, the DPD control configuration information comprising one or more of:
an indication type for the DPD guidance information;
a format for the DPD guidance information;
an indication of periodic mode for DPD guidance, with an indication period; and
an indication of aperiodic mode for DPD guidance, with an indication of a trigger for DPD guidance information;
wherein receiving the DPD guidance information is performed in accordance with the DPD control configuration information.

36. The method of claim 29, further comprising:
sending DPD application configuration information to the second device, the DPD application configuration information comprising one or more of:
an indication of a DPD mode;
an indication of a residual non-linearity characteristic; and
a residual impairment metric.

37. The method of claim 36, wherein the method comprises sending a plurality of DPD application configurations to the second device, each DPD application configuration comprising DPD application configuration information according to claim 36, wherein the DPD guidance information received from the second device includes an index to one of the plurality of DPD application configurations and wherein adapting DPD processing at the first device based on the DPD guidance information comprises applying the DPD application configuration corresponding to the index.

38. The method of claim 29, further comprising:
sending a request for DPD guidance information to the second device, wherein the DPD guidance information is received in response to the request.

39. The method of claim 29, wherein performing DPD processing based on the received DPD guidance information comprises adapting DPD processing based on the received DPD guidance information.

40. The method of claim 39, wherein adapting DPD processing based on the received DPD guidance information comprises one or more of:
activating or deactivating DPD operation;
adapting DPD mode;
adapting one or more DPD parameters; and
adapting to which signal types, channels, time slots, and/or symbols DPD is applied.

41. A method, in a first device, the method comprising:
sending, to a second device, digital-predistortion, DPD, guidance information, the DPD guidance information being indicative of whether and/or how and/or to what extent to perform DPD processing at the second device.

42. The method of claim 41, further comprising:
receiving DPD guidance capability information from the second device, the DPD guidance capability information indicating support for one or more of:
one or more predetermined DPD configurations;
a DPD activation indication;
a DPD mode change indication;
indications to change one or more DPD parameters;
an indication or characteristic of residual non-linearity in a signal received at the first device;
a metric of residual impairment to a signal received at the first device; and
an index to a DPD configuration from among a plurality of predetermined DPD configurations.

43. The method of claim 41, further comprising:
sending DPD preference information to the second device, the DPD preference information indicating one or more of:
a preference for one or more predetermined DPD configurations;
a preference for one or more DPD modes; and
a desired or required maximum distortion level of transmitter output at the second device.

44. The method of claim 41, further comprising:
receiving DPD control configuration information from the second device, the DPD control configuration information comprising one or more of:
an indication type for the DPD guidance information;
a format for the DPD guidance information;
an indication of periodic mode for DPD guidance, with an indication period; and
an indication of aperiodic mode for DPD guidance, with an indication of a trigger for DPD guidance information;
wherein sending the DPD guidance information is performed in accordance with the DPD control configuration information.

45. The method of claim 29, wherein the first device is a user equipment (UE) and the second device is a base station, or wherein the first device is a base station and the second device is a UE.

46. An apparatus comprising receiver circuitry, transmitter circuitry, and processing circuitry operatively coupled to the receiver circuitry and transmitter circuitry, wherein the processing circuitry is configured to use the receiver circuitry and transmitter circuitry to carry out a method according to claim 29.

47. A network node comprising the apparatus of claim 46.

48. A user equipment, UE, comprising the apparatus of claim 46.
